(19) United States
(12) Patent Application Publication
(10) Pub. No.: US 2025/0379386 A1
(43) Pub. Date: Dec. 11, 2025

(54) PLUG TERMINAL, SOCKET TERMINAL, AND CONNECTOR

(71) Applicant: Tyco Electronics (Shanghai) Co., Ltd., Shanghai (CN)

(72) Inventors: XinXin (Daisy) Li, Shanghai (CN); Liming (Eric) Wang, Shanghai (CN); Zebin (Donnie) Tang, Shanghai (CN); Yang (Leon) Zou, Shanghai (CN); Zhenyu (Richard) Chen, Shanghai (CN); Feng (Will) Chen, Shanghai (CN)

(73) Assignee: Tyco Electronics (Shanghai) Co., Ltd., Shanghai (CN)

(21) Appl. No.: 19/230,762

(22) Filed: Jun. 6, 2025

(30) Foreign Application Priority Data
Jun. 7, 2024 (CN) 202410741747.6

(51) Int. Cl. H01R 13/17; H01R 13/187

(52) U.S. Cl. CPC H01R 13/17; H01R 13/187

(57) ABSTRACT

A plug terminal includes a cable connection portion and an insertion portion. The insertion portion is inserted into a socket terminal. The insertion portion has a body plate, an elastic sheet having resilience, and two contact side plates. One end of the elastic sheet extends and is bent from a middle portion of the body plate. An other end of the elastic sheet extends in a direction away from the body plate. The other end of the elastic sheet has a pressing portion. Each contact side plate extends on one side of the body plate and is in electrical contact with the socket terminal.

### CROSS-REFERENCE TO RELATED APPLICATIONS

This application claims the benefit of the filing date under 35 U.S.C. § 119(a)-(d) of Chinese Patent Application No. CN 202410741747.6, filed on Jun. 7, 2024 and Chinese Patent Application CN 202510488163.7.

### FIELD OF THE INVENTION

The present invention relates to the field of terminals and, more particularly, to a plug terminal, a socket terminal, and a connector.

### BACKGROUND OF THE INVENTION

A connector is a coupling device that connects electrical terminals to form an electrical circuit, and may implement a connection between a wire, a printed circuit board, and an electronic component. For example, a plug terminal crimped with a wire may be inserted into a socket terminal mounted on a substrate to achieve the connection between the wire and the substrate.

The connector is widely used in industrial fields such as household appliances, automobiles, and electronics. The device to which the connector is applied may be in a harsh operating environment or may need to be assembled and transported over long distances. During this time, these devices inevitably experience vibrations caused by external forces. Therefore, there is an urgent need to provide a connector with a relatively high connection reliability.

### SUMMARY OF THE INVENTION

A plug terminal includes a cable connection portion and an insertion portion. The insertion portion is inserted into a socket terminal. The insertion portion has a body plate, an elastic sheet having resilience, and two contact side plates. One end of the elastic sheet extends and is bent from a middle portion of the body plate. An other end of the elastic sheet extends in a direction away from the body plate. The other end of the elastic sheet has a pressing portion. Each contact side plate extends on one side of the body plate and is in electrical contact with the socket terminal.

### BRIEF DESCRIPTION OF DRAWINGS

The invention will now be described by way of example with reference to the accompanying figures, of which:

FIG. 1 is a perspective view of a plug terminal and a socket terminal according to an exemplary embodiment;

FIG. 2 is another perspective view of the plug terminal of FIG. 1 and the socket terminal of FIG. 1;

FIG. 3 is a longitudinal cross-sectional view of the socket terminal of FIG. 1;

FIG. 4 is a perspective view of a connector according to an exemplary embodiment;

FIG. 5 is a horizontal cross-sectional view of the connector of FIG. 4;

FIG. 6 is a perspective view of a plug terminal and a socket terminal according to another exemplary embodiment;

FIG. 7 is a perspective view of the socket terminal of FIG. 6 with a side wall removed;

FIG. 8 is a perspective view of the socket terminal of FIG. 6 with a top wall removed;

FIG. 9 is a perspective view of a connector according to another exemplary embodiment;

FIG. 10 is a longitudinal cross-sectional view of the connector of FIG. 9 taken along line A-A of FIG. 9;

FIG. 11 is a perspective view of the plug terminal of FIG. 6 and a socket terminal according to another exemplary embodiment;

FIG. 12 is a perspective view of the socket terminal of FIG. 11 with a side wall removed; and

FIG. 13 is a longitudinal cross-sectional view of a connector according to another exemplary embodiment.

### DETAILED DESCRIPTION

The following further describes the technical solutions of the present disclosure in detail by means of embodiments and in conjunction with the accompanying drawings. In the specification, the same or similar reference signs indicate the same or similar components. The following description of the embodiments of the present disclosure with reference to the accompanying drawings is intended to explain the general inventive concept of the present disclosure, and should not be construed as limiting the present disclosure.

The terms “including”, “comprising”, and similar terms used herein should be understood as open terms, that is, “including/including but not limited to” means that other contents may also be included. The term “based on” means “based at least in part on.” The term “one example” means “at least one example”; the term “another example” means “at least one additional example”, etc.

According to one general concept of the present disclosure, a plug terminal and a socket terminal are provided. The plug terminal includes an insertion portion and a cable connection portion, where the insertion portion is configured to be inserted into the socket terminal. The insertion portion includes a body plate, an elastic sheet having resilience, and two contact side plates. One end of the elastic sheet extends and is bent from a middle portion of the body plate. The other end of the elastic sheet extends at an angle in a direction away from the body plate. A pressing portion is provided on a surface of the other end of the elastic sheet. The two contact side plates extend on both sides of the body plate. The two contact side plates are configured to be in contact with the socket terminal. The socket terminal includes a cavity receiving portion and an open receiving portion. The cavity receiving portion is defined by a bottom wall, two side walls, and a top wall. The open receiving portion is defined by the bottom wall and the two side walls. The open receiving portion and the cavity receiving portion are provided for the plug terminal to be inserted in sequence. The open receiving portion includes two limit handles, which are respectively formed by bending from tops of the two side walls. The cavity receiving portion further includes two bending elastic arms, which extend inward of the cavity receiving portion. The two bending elastic arms are configured to be in contact with the plug terminal.

In this present disclosure, the contact side plates of the plug terminal are pressed by and in contact with the bending elastic arms of the socket terminal. The plug terminal may be limited by the top wall, the bottom wall, and the side walls of the socket terminal in the up, down, left, and right directions, thereby improving connection stability.

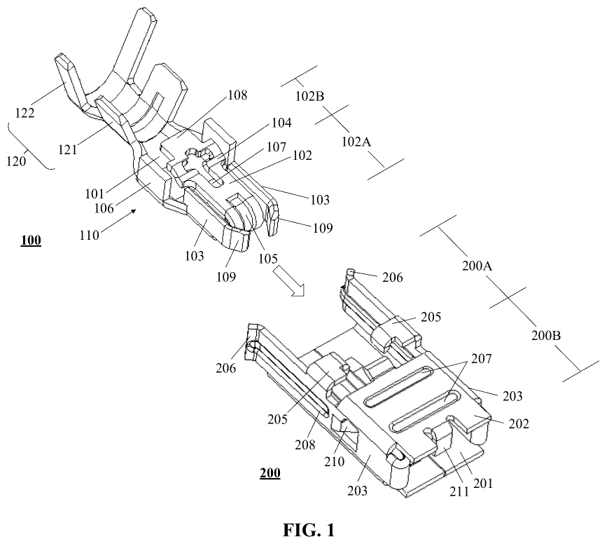

An exemplary embodiment of a plug terminal 100 and a socket terminal 200 will now be described with reference to FIGS. 1-5.

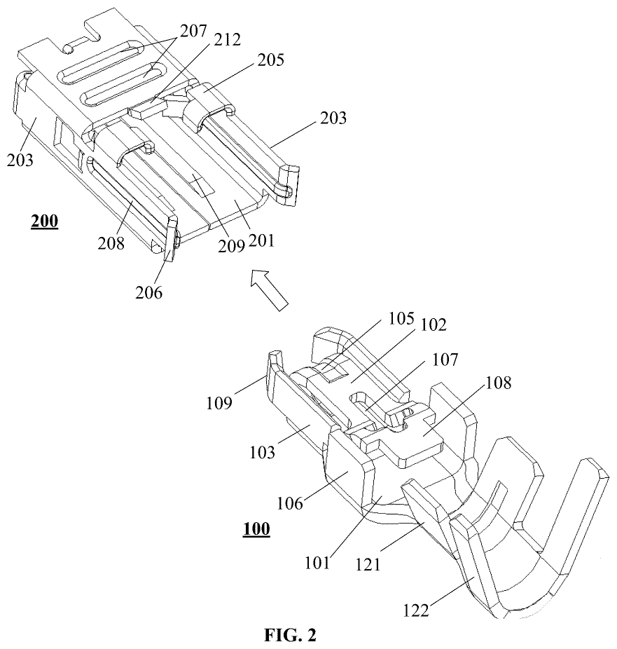

As shown in FIGS. 1-2, the plug terminal 100 is inserted along an insertion direction (shown by the hollow arrow) into the socket terminal 200 mated with the plug terminal 100. The bottom of the socket terminal 200 is flat and may be mounted on a printed circuit board. As shown in FIG. 1, the plug terminal 100 includes an insertion portion 110 and a cable connection portion 120. The insertion portion 110 is configured to be in contact with and connected to the socket terminal. The cable connection portion 120 is configured to fix and connect the cable. In some embodiments, the insertion portion 110 and the cable connection portion 120 are integrally formed. For example, the insertion portion 110 and the cable connection portion 120 may be stamped and cut from a single sheet of metal.

As shown in FIGS. 1-2, the insertion portion 110 includes a body plate 101, a resilient elastic sheet 102, and two contact side plates 103. As shown in FIG. 1, one end 102A of the elastic sheet 102 extends and bends from a middle portion of the body plate 101, and the other end 102B of the elastic sheet 102 extends at an angle in a direction away from the body plate 101. The arrangement of the elastic sheet 102, inclined relative to the body plate 101, can ensure the elasticity of the elastic sheet 102.

As shown in FIG. 1, the surface of the other end 102B of the elastic sheet 102 is provided with a pressing portion 104 recessed towards the inside of the surface. During insertion of the plug terminal 100 into the socket terminal 200, one end 102A of the elastic sheet first enters the socket terminal, and when the pressing portion 104 travels to the socket terminal, the pressing portion 104 is pressed. When travelling is complete, the elastic sheet 102 rebounds and makes an audible sound. The sound may serve as an indication that the plug terminal and the socket terminal are completely connected so as to improve connection efficiency. In addition, when the pressing portion 104 is pressed to cause the elastic sheet 102 to rebound, the plug terminal 100 and the socket terminal 200 may be locked. In some embodiment, during insertion of the plug terminal 100 into the socket terminal 200, the pressing portion 104 is not in contact with the top wall edge of the socket terminal 200. In this case, sound is generated by vibration. In some other embodiments, during insertion of the plug terminal 100 into the socket terminal 200, the pressing portion 104 is in contact with the top wall edge of the socket terminal 200. In this case, sound is generated by impact. The sound of the elastic sheet 102 rebounding is related to the structure of the two terminals. In the embodiments shown in FIGS. 1-2, the intensity of the sound may be greater than 60 dB.

The two contact side plates 103 are formed by perpendicularly bending upward from the left and the right side of the body plate 101. As shown in FIGS. 1-2, the two contact side plates 103 are bent upward at an angle of about 90 degrees. Here, left and right refer to the width directions perpendicular to the insertion direction. Upward and downward refer to thickness directions perpendicular to the insertion direction. Since the two contact side plates 103 and the elastic sheet 102 are both formed on the upper surface of the body plate 101, the two contact side plates 103 and the elastic sheet 102 are located on the same side of the body plate 101. There are gaps between the left and right sides of the elastic sheet 102 and the two contact side plates 103 to facilitate compression and rebound of the elastic sheet. The outer facades of the two contact side plates 103 are used to contact the socket terminal 200.

Correspondingly, FIGS. 1-2 also show the socket terminal 200 mated with the plug terminal 100. As shown in FIG. 1, the socket terminal 200 includes a bottom wall 201, a top wall 202, and two side walls 203. The two side walls 203 are symmetrically disposed on the left and right sides of the bottom wall 201. The top wall 202 and the bottom wall 201 are asymmetrically disposed, that is, the top wall 202 does not completely cover the bottom wall 201. As shown in FIG. 1, the bottom wall 201 and the two side walls 203 define an open receiving portion 200A, while the bottom wall 201, the two side walls 203, and the top wall 202 define a cavity receiving portion 200B. The open receiving portion 200A and the cavity receiving portion 200B allow the plug terminal 100 to be inserted sequentially, that is, the plug terminal 100 first enters the open receiving portion 200A and then enters the cavity receiving portion 200B. In some embodiments, the socket terminal may be used to receive not only the insertion portion 110 of the plug terminal 100, but also at least a portion of the cable connection portion 120 of the plug terminal 100, such as the portion of the wire core connection roll 121 shown in FIG. 4.

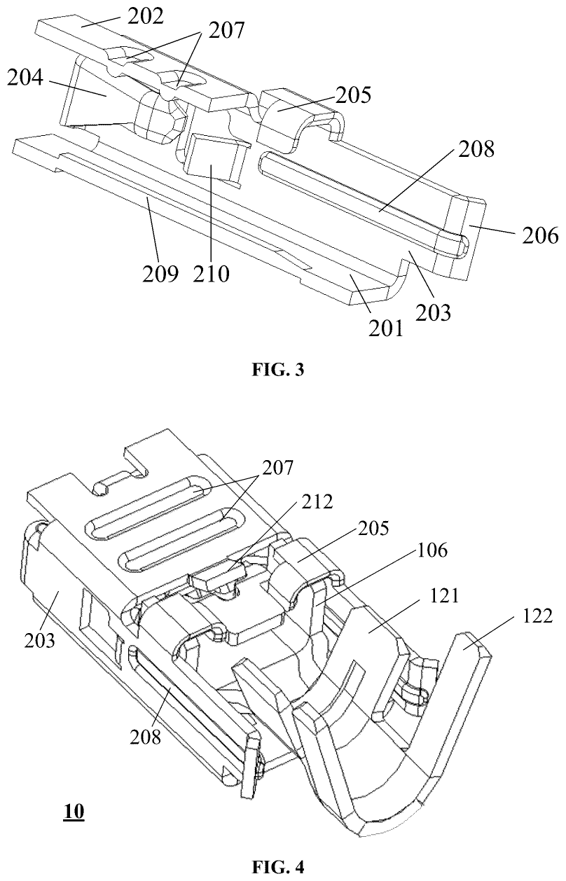

The cavity receiving portion 200B includes two bending elastic arms 204. As shown in FIG. 3, each bending elastic arm 204 is bent at the edge of the side wall 203 and extends into the cavity receiving portion 200B, that is, the bending elastic arm 204 extends in a direction opposite to the insertion direction of the plug terminal 100. In a non-connected state, the free end of the bending elastic arm 204 is not in contact with the inner surface of the side wall 203, and extends at an angle with the inner surface of the side wall 203. As shown in FIG. 3, the bending elastic arm 204 has a bent end structure at its free end. The structure of the bending elastic arm 204 is not limited to the shown embodiment. In other embodiments, the elastic arm 204 is only required to be elastically compressed toward the inner surface of the side wall 203.

As shown in FIG. 1, the open receiving portion 200A of the socket terminal 200 includes two limiting handles 205. The two limiting handles 205 are respectively bent from the tops of the two side walls 203. The two limiting handles 205 may press the elastic sheet 102 to elastically deform during the insertion of the plug terminal 100 into the open receiving portion 200A, and finally make the elastic sheet 102 rebound and lock the elastic sheet 102.

Specifically, in the process of inserting the plug terminal 100 into the socket terminal 200, the plug terminal 100 first passes through the open receiving portion 200A. In the inserting process, the pressing portion 104 on the other end 102B of the elastic sheet 102 is pressed by the limiting handles 205. After the insertion of the plug terminal ends 102A, 102B, the elastic sheet 102 rebounds and makes a sound, and the limiting handles 205 are clamped with the elastic sheet 102 to lock the plug terminal 100 and the socket terminal 200.

When the plug terminal 100 enters the cavity receiving portion 200B, each contact side plate 103 contacts the corresponding bending elastic arm 204 and presses the bending elastic arm from the left or right side.

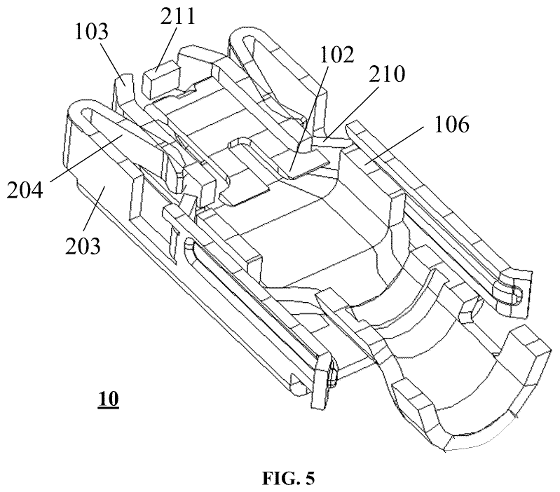

As shown in FIG. 5, outer facades of the two contact side plates 103 of the plug terminal 100 are in contact with the socket terminal 200. On the other hand, the bent outer surfaces of the two bending elastic arms 204 of the socket terminal 200 are in contact with the plug terminal 100. In other words, as shown in FIG. 5, the outer facades of the two contact side plates 103 are in contact with the bent outer surfaces of the two bending elastic arms 204.

Compared with a blade type plug terminal, the left and right outer sides of the plug terminal 100 are pressed by and in contact with the left and right inner sides of the socket terminal 200, while the plug terminal 100 can be limited by the bottom wall 201 and the top wall 202 of the socket terminal 200 in the up-down direction. The plug terminal 100 can be secured in all four directions, thereby increasing the stability of the connection. In addition, the plug terminal 100 and the socket terminal 200 are contacted on the left and right sides, and compared to terminals being contacted in the up and down directions, which facilitates the reduction of the height of the terminals 100,200 and is suitable for small-sized terminals.

As shown in FIGS. 1-2, the elastic sheet 102 may further include a reinforcing rib 105 located at the middle portion of one end 102A of the elastic sheet and extending toward the other end 102B of the elastic sheet. The reinforcing rib 105 may be elongated and disposed at the bending position of the elastic sheet 102, which can increase the strength of the plug terminal 100.

As shown in FIGS. 1-2 and 5, The plug terminal 100 may further include two limiting side plates 106 provided on the left and right opposite sides thereof. From the insertion direction of the plug terminal 100, the limiting side plates 106 are located behind the contact side plate 103. The limiting side plates 106 may be formed by bending upward from the left and right sides of the body plate 101. The limiting side plates 106 serve to limit the plug terminal 100 to the left and right. The outer facades of the limiting side plates 106 do not need to be in contact with the socket terminal 200, and thus the distance between the two limiting side plates 106 may be greater than the distance between the two contact side plates 103. In addition, as shown in FIG. 1, the position of the limiting side plates 106 corresponds to the position of the other end 102B of the elastic sheet. Since the elastic sheet 102 extends at an angle with respect to the body plate 101, the height of the limiting side plates 106 may be higher than the height of the contact side plates 103.

As shown in FIG. 4, when the plug terminal 100 and the socket terminal 200 are connected, the limiting handles 205 are located above the limiting side plates 106. When the plug terminal 100 or the socket terminal 200 is vibrated in the up-down direction, the limiting handles 205 may also fix the plug terminal 100 in the up-down direction.

As shown in FIG. 1, one end 102A of the elastic sheet 102 may be a portion that enters the cavity receiving portion 200B of the socket terminal 200, and the remaining portion of the elastic sheet 102 may be the other end 102B of the elastic sheet. Two sides of one end 102A of the elastic sheet 102 may correspond to the two contact side plates 103. Two sides of the other end 102B of the elastic sheet 102 may correspond to the two limiting side plates 106. In this way, a width of one end 102A of the elastic sheet may be less than a width of the other end 102B of the elastic sheet, to facilitate sound generation when the two terminals 100,200 are in contact.

As shown in FIGS. 1-2, a tongue-shaped flat protrusion 108 may also be provided in the middle of the edge of the other end 102B of the elastic sheet 102, which extends along the extending direction of the elastic sheet 102 and has a flat non-curved surface. When the plug terminal 100 and the socket terminal 200 need to be decoupled, the elastic sheet 102 may be pressed down by pressing the flat protrusion 108 with a decoupling jig. The plug terminal 100 is then pulled out of the socket terminal 200 in the pulling direction (the direction opposite to the hollow arrow (See FIGS. 1-2)).

In some embodiments, such as the embodiment shown in FIGS. 1-2, the elastic sheet 102 further includes a hole 107 extending along the insertion direction and through the pressing portion 104. The arrangement of the hole 107 facilitates sound generation when the elastic sheet is pressed back. The shape of the hole 107 may be in various forms, as shown in FIGS. 1-2, the hole 107 may be cross-shaped, meaning not only is the hole 107 elongated along the insertion direction and penetrating the pressing portion 104, but the hole 107 is also elongated along the left-right direction on the pressing portion 104 in the vicinity of the direction away from the end 102A of the elastic sheet 102.

In some embodiments, the pressing portion 104 on the elastic sheet 102 may be curved. In the embodiment shown in FIGS. 1-2, a portion of the other end 102B of the elastic sheet 102 close to the pressing portion 104 may also be curved. The arrangement of the curved surface facilitates the sound when the elastic sheet 102 rebounds. In some other embodiments, the pressing portion 104 may also be a planar surface set diagonally, and the portion proximate the pressing portion 104 may also be planar.

In some embodiments, such as the current embodiment shown in FIGS. 1-2, the plug terminal 100 may further include two insertion guide portions 109 respectively extending from the two contact side plates 103 and bending toward the midline of the end 102A of the elastic sheet 102. The two insertion guide portions 109 are respectively bent in the width direction of the plug terminal 100 from each side of the plug terminal 100 toward the center. In this way, when the plug terminal 100 is close to the socket terminal 200, the plug terminal 100 and the socket terminal 200 are more easily aligned, thus improving the connection efficiency.

Correspondingly, as shown in FIGS. 1-2, the open receiving portion 200A of the socket terminal 200 may further include two receiving guide portions 206. The two receiving guide portions 206 respectively extend from the two side walls 203 and are bent in a direction away from a midline of the socket terminal 200, that is, bent in directions of the left and right sides of the socket terminal 200. As shown in FIGS. 1-2, the receiving guide portions 206 are outwardly open. When the plug terminal 100 is close to the socket terminal 200, it is easier to receive the plug terminal 100, thereby improving the connection efficiency between the plug terminal 100 and the socket terminal 200.

As shown in FIGS. 1-2 and 4, the cable connection portion 120 of the plug terminal 100 further includes a wire core connection roll 121 and a wire shell connection roll 122. The wire core connection roll 121 is closer to the insertion portion 110 than the wire shell connection roll 122. The wire core connection roll 121 is used to fix and connect an exposed wire core of a cable. The wire shell connection roll 122 is used to fix a wire shell of the cable. In some embodiments, the inner surface of the wire core connection roll 121 is provided with a convex transverse pressing line for pressing the exposed wire core. Additionally, in some embodiments, the plug terminal 100 may be in a linear configuration. For example, as shown in FIGS. 1-2, center lines of the wire core connection roll 121, the wire shell connection roll 122, and the insertion portion 110 are located on a same straight line.

Returning now to the socket terminal 200, the top of the socket terminal 200 may be provided with at least one inwardly protruding rib. For example, as shown in FIGS. 1-4, the cavity receiving portion 200B includes two convex ribs 207, which are arranged at uniform intervals. As shown in FIG. 1, the two convex ribs 207 are located on the top wall 202 and protrude into the cavity receiving portion 200B. When viewed from above the socket terminal 200, the two convex ribs 207 are recessed downward. The arrangement of the convex ribs 207 can increase the contact between the top wall 202 of the socket terminal 200 and the elastic sheet 102 of the plug terminal 100, so as to improve the connection stability of the two terminals 100,200.

Similarly, the sides of the socket terminal 200 may also include side convex ribs 208. For example, as shown in FIGS. 1-4, the open receiving portion 200A includes two side convex ribs 208, each of which is located on a side wall 203 and protrudes into the open receiving portion 200A. Viewed from the left and right sides of the socket terminal 200, the side convex ribs 208 are recessed inward. The side convex ribs 208 can increase the contact between the side walls 203 of the socket terminal 200 and the insertion portion 110 of the plug terminal 100 (such as the limiting side plates 106 of the insertion portion 110 close to the cable connection portion 120). When the terminal is subjected to vibration in the left-right direction, the connection stability of the two terminals 100,200 can be improved. The length of the side convex ribs 208 may be specifically set according to actual requirements. For example, the length of the side convex rib 208 may correspond to the length of the limiting side plate 106. Alternatively, as shown in FIGS. 1-4, the side convex rib 208 extends a portion of the side wall 203 located at the cavity receiving portion 200B, and may even reach the receiving guide portion 206.

The bottom of the socket terminal 200 may also include at least one convex rib. For example, as shown in FIGS. 2-3, the middle portion of the bottom wall 201 of the socket terminal 200 is provided with two convex ribs 209, which are respectively located on two sides of the center line of the bottom wall 201 and extend along the length direction of the bottom wall 201. As shown in FIG. 3, the two convex ribs 209 protrude into the socket terminal 200. The convex ribs 209 are recessed inwardly when viewed upward from the bottom of the socket terminal 200. The arrangement of the convex ribs 209 can increase the contact between the bottom wall 201 of the socket terminal 200 and the body plate 101 of the plug terminal 100, so as to improve the connection stability of the two terminals 100,200.

In some embodiments, the convex ribs 207, 208, 209 may be stamped and formed on a substrate.

The socket terminal 200 may be integrally formed by cutting and bending on the basis of one substrate. For example, as shown in FIGS. 1-2 and 4, the socket terminal 200 is a symmetrical structure, which may be formed by the top wall 202 as a base, respectively 90-degree bending to form side walls 203, and again 90-degree relative bending to form the bottom wall 201. The bottom wall 201 is composed of two half plates. In some other embodiments, the socket terminal 200 may alternatively be based on one side wall, where a top wall is formed by bending at 90 degrees, another side wall is formed by bending at 90 degrees again, and the bottom wall is formed by bending at 90 degrees again. In the some other embodiments, the bottom wall is clamped to the one side wall, and in this case, the bottom wall is a complete plate.

In the socket terminal 200, in addition to the limiting handles 205, a limiting member may also be provided at other positions. For example, in some embodiments, such as the present embodiment, the cavity receiving portion 200B of the socket terminal 200 further includes a concave side plate 210. As shown in FIGS. 1 and 3, in the cavity receiving portion 200B, each side wall 203 is provided with a concave side plate 210, which is bent at an angle inward of the cavity receiving portion 200B in a direction away from the side wall 203. As shown in FIG. 5, when the plug terminal 100 and the socket terminal 200 are in a connected state, the concave side plate 210 may limit a partial region of the plug terminal 100, such as the limiting side plate 106. Since the concave side plate 210 is concave inward like a movable leaf, a hole is formed at a corresponding position of the side wall 203. The hole can make way when the bending elastic arm 204 of the socket terminal 200 is pressed.

For another example, in some embodiments, the trailing portion of the cavity receiving portion 200B of the socket terminal 200 further includes a limiting stop portion 211. The tailing portion here refers to the portion of the socket terminal 200 that finally reaches the plug terminal 100. As shown in FIGS. 1 and 5, the limiting stop portion 211 is located at an edge of the top wall 202 and bent downward. The limiting stop portion 211 may have a certain rigidity. In this way, when the plug terminal 100 is inserted into the socket terminal 200, further insertion is prevented when the foremost end of the plug terminal 100 reaches the limiting stop portion 211 of the socket terminal 200.

The intermediate position of the edge on the cavity receiving portion 200B opposite the limiting stop portion 211 also includes an upward protrusion 212, as shown in FIGS. 2 and 4. When the plug terminal 100 and the socket terminal 200 are in the connected state, the protrusion 212 corresponds to the position of the hole 107 and is adjacent to the flat protrusion 108. In this way, when decoupling is required, the jig can be prevented from being accidentally touched, thereby improving decoupling efficiency.

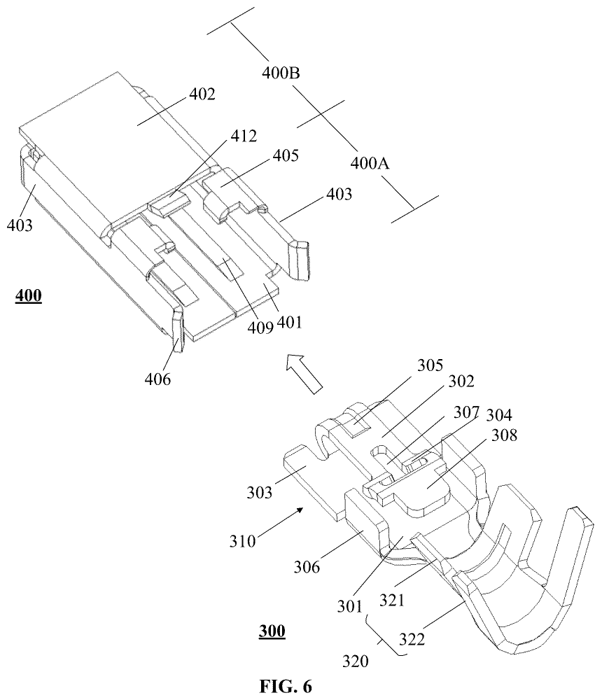

An exemplary embodiment of a plug terminal 300 and a socket terminal 400 will now be described with reference to FIGS. 6-10.

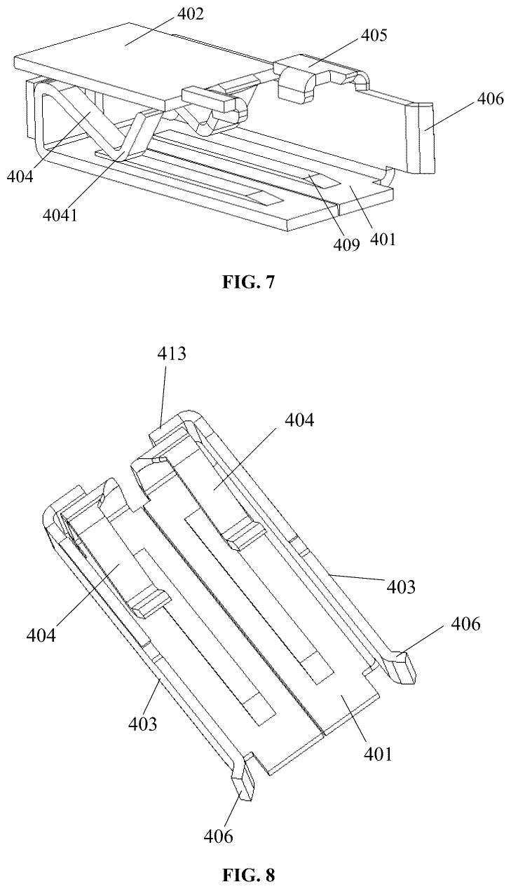

Differences between the exemplary embodiment according to FIGS. 1-5 and the exemplary embodiment according to FIGS. 6-10 include: the contact side plate 303, as shown in FIGS. 6 and 10, of the plug terminal 300 is different from the contact side plate 103, as shown in FIGS. 1-2, in the plug terminal 100; and the bending elastic arm 404, as shown in FIGS. 7-8 and 10, of the socket terminal 400 is different from the bending elastic arm 204, as shown in FIGS. 3 and 5, of the socket terminal 200. The parts of the exemplary embodiment according to FIGS. 1-5 and the exemplary embodiment according to FIGS. 6-10 that are different are specified below, while other similar parts are not repeated. In addition, some components shown in the illustration of the exemplary embodiment according to FIGS. 1-5 and components not shown in the illustration of the exemplary embodiment according to FIGS. 6-10 may also be applied to the exemplary embodiment according to FIGS. 6-10, such as the convex rib 207, the side convex rib 208, the concave side plate 210, the limiting stop portion 211, etc.

As shown in FIG. 6, in the illustrated exemplary embodiment, the plug terminal 300 is inserted along an insertion direction (shown by a hollow arrow) into the socket terminal 400 mated with the plug terminal 300. As further shown in FIG. 6, the plug terminal 300 includes an insertion portion 310 and a cable connection portion 320.

As shown in FIG. 6, the insertion portion 310 includes a body plate 301, a resilient elastic sheet 302, and two contact side plates 303. One end of the elastic sheet 302 extends and bends from a middle portion of the body plate 301. The other end of the elastic sheet 302 extends at an angle in a direction away from the body plate 301. The arrangement of the elastic sheet 302 inclined relative to the body plate 301 can ensure the elasticity of the elastic sheet 302.

As shown in FIG. 6, the surface of the other end of the elastic sheet 302 is provided with a pressing portion 304 recessed towards the inside of the surface. The two contact side plates 303 extend from the left and right side planes of the body plate 301. As shown in FIG. 6, the elastic sheet 302 is formed on an upper surface of the body plate 301. The surfaces of the two contact side plates 303, i.e., the upper surfaces, are used to contact the socket terminal. The contact surfaces of the two contact side plates 303 and the elastic sheet 302 are located on the same side of the body plate 301. Here, left and right refer to directions in width perpendicular to the insertion direction. Upward and downward refer to directions in thickness perpendicular to the insertion direction. Grooves may be provided between the left and right sides of the elastic sheet 302 and the two contact side plates 303.

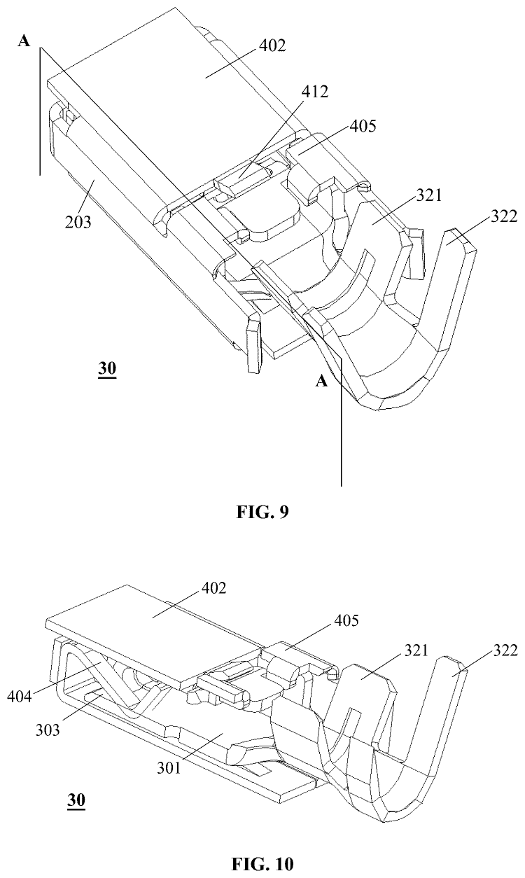

Correspondingly, FIGS. 9-10 also show the plug terminal 300 mated with the socket terminal 400. As shown in FIGS. 6-7, the socket terminal 400 includes a bottom wall 401, a top wall 402, and two side walls 403. As shown in FIG. 6, the bottom wall 401 and the two side walls 403 define an open receiving portion 400A, while the bottom wall 401, the two side walls 403, and the top wall 402 define a cavity receiving portion 400B. The open receiving portion 400A includes two limiting handles 405. The plug terminal 300 is sequentially inserted into the open receiving portion 400A and the cavity receiving portion 400B. In some examples, the socket terminal 400 may be used to receive not only the insertion portion 310 of the plug terminal 300, but also at least a portion of the cable connection portion 320 of the plug terminal 300, such as the portion of the wire core connection roll 321 shown in FIG. 9.

As shown in FIGS. 7-8 and 10, the cavity receiving portion 400B includes two bending elastic arms 404. One end of the bending elastic arm 404 extends and is bent from both sides of the bottom wall 401, and the other end (free end) of the bending elastic arm 404 extends into the cavity receiving portion 400B. As shown in FIG. 7, the other end of the bending elastic arm 404 includes a bending portion 4041, that is, a bending structure is provided at the end of the free end of the bending elastic arm 404. The bending portion 4041 and the bending elastic arm 404 form a V-shaped structure. A bottom end surface of the bending portion 4041 may be in contact with the plug terminal 300.

During the contact and insertion of the plug terminal 300 and the socket terminal 400, the plug terminal 300 first passes through the open receiving portion 400A. In the inserting process, the pressing portion 304 on the elastic sheet 302 is pressed by the limiting handles 405. After the insertion of the plug terminal ends, the elastic sheet 302 rebounds and makes a sound, and the limiting handles 405 are clamped with the elastic sheet 302 to lock the plug terminal 300 and the socket terminal 400.

When the plug terminal 300 enters the cavity receiving portion 400B, each contact side plate 303 is inserted between the bending portion 4041 and the bottom wall 401, and the bending elastic arms 404 press the contact side plates 303 downward. As shown in FIG. 10, an upper surface of each contact side plate 303 is in contact with the corresponding bending elastic arm 404, and a lower surface of each contact side plate 303 is pressed and in contact with the bottom wall 401.

It can be understood that the structure of the bending elastic arms 404 is not limited to the exemplary embodiment according to FIGS. 6-10. In other embodiments, the bending elastic arms 404 only needs to be elastically compressed toward the upper surface inside the bottom wall 401.

As shown in FIG. 7, in the non-connected state, the free end of the bending elastic arm 404 may be in contact with the upper surface of the bottom wall 401. In some other embodiments, the free end of the bending elastic arm 404 may be in a non-contact state with the upper surface of the bottom wall 401, where the distance between the two should be less than the thickness of the contact side plate 303 to ensure good contact.

Compared with the plug terminal of the blade type, the upper and lower sides of the contact side plates 303 of the plug terminal 300 are respectively in pressing contact with the bending elastic arms 404 and the bottom wall 401 of the socket terminal 400. In addition, the upper, left, and right sides can be limited by the top wall 402 and the side walls 403 of the socket terminal 400, thereby improving the connection stability. In addition, the two terminals 300,400 are in top and bottom contact with each other. Due to the increased contact area, the two terminals 300,400 can be applied to specific cases of transmission current requirements, such as high current situations.

As shown in FIG. 6, the elastic sheet 302 may further include a reinforcing rib 305. The plug terminal 300 may further include two limiting side plates 306 provided on the left and right opposite sides thereof. As shown in FIG. 6, a tongue-shaped flat protrusion 308 may also be provided in the middle of the edge of the other end of the elastic sheet 302. The elastic sheet 302 further includes a hole 307 extending along the insertion direction and through the pressing portion 304. The cable connection portion 320 of the plug terminal 300 also includes a wire core connection roll 321 and a wire shell connection roll 322.

As shown in FIG. 6, the open receiving portion 400A of the socket terminal 400 may also include two receiving guide portions 406. The bottom wall 401 of the socket terminal 400 may be provided with at least one inward convex rib 409. In some embodiments, the top wall 402 or the side walls 403 of the socket terminal 400 may also be provided with at least one inward convex rib 409. The middle position of the edge of the cavity receiving portion 400B may further include an upward protrusion 412, as shown in FIGS. 6 and 9.

Referring now to FIG. 8, the cavity receiving portion 400B further includes two receiving support portions 413, which extend from the two side walls 403 respectively and are bent toward the midline of the socket terminal 400. The receiving support portions 413 may support the bending elastic arms 404 to ensure an elastic force.

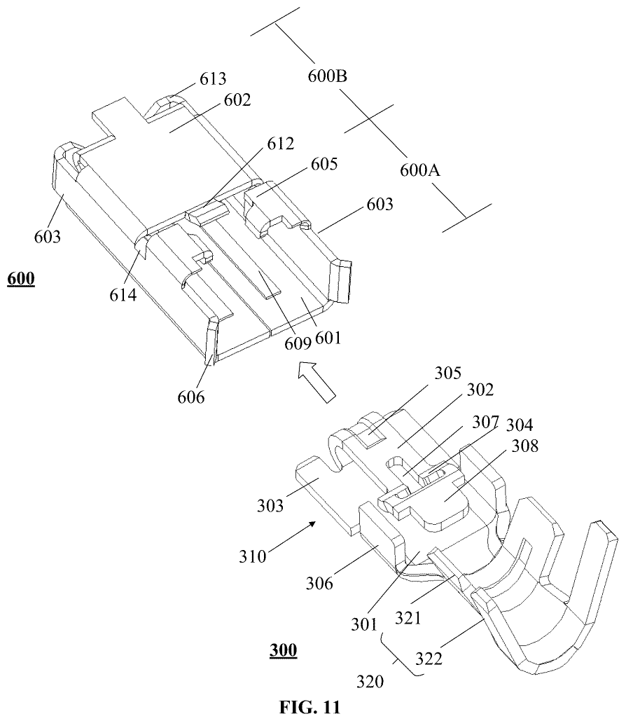

An exemplary embodiment of a socket terminal 600 will now be described with reference to FIGS. 11-13.

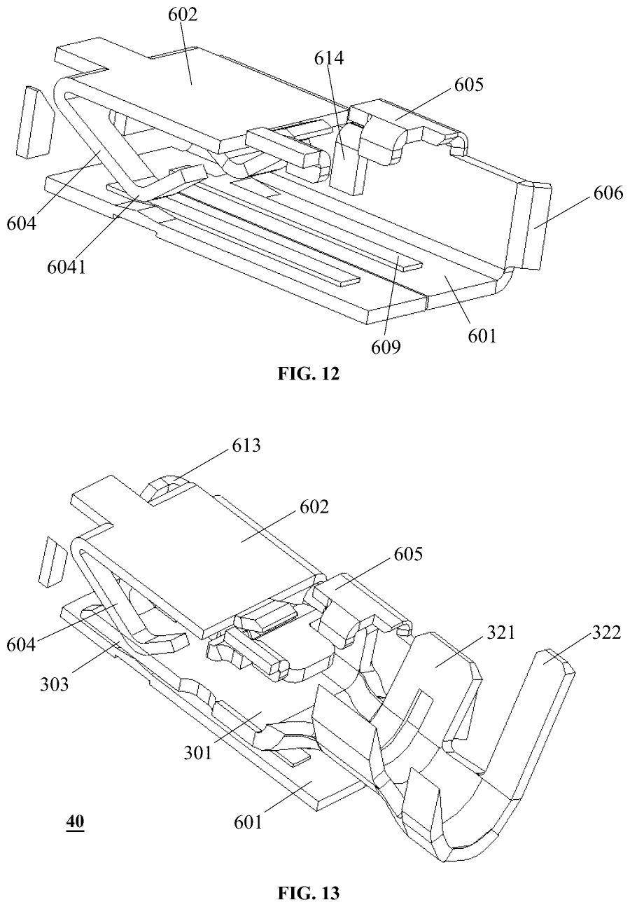

Differences between the exemplary embodiment according to FIGS. 6-10 and the exemplary embodiment according to FIGS. 11-13 include: the bending elastic arms 404, as shown in FIGS. 7-8 and 10, extend from the bottom wall 401, while the bending elastic arms 604, as shown in FIGS. 12-13, extend from the top wall 602. Compared with the upper forming of the bending elastic arms 404, the lower forming of the bending elastic arms 604 can reduce the difficulty of stamping and forming the socket terminal 600. The parts of the exemplary embodiment according to FIGS. 6-10 and the exemplary embodiment according to FIGS. 11-13 that are different are specified below, while other similar parts are not repeated.

FIG. 13 illustrates the socket terminal 600 mated with the plug terminal 300. As shown in FIGS. 11-12, the socket terminal 600 includes a bottom wall 601, a top wall 602, and two side walls 603. As shown in FIG. 11, the bottom wall 601 and the two side walls 603 define an open receiving portion 600A, while the bottom wall 601, the two side walls 603, and the top wall 602 define a cavity receiving portion 600B. As shown in FIGS. 11-13, the open receiving portion 600A includes two limiting handles 605. The plug terminal 300 is sequentially inserted into the open receiving portion 600A and the cavity receiving portion 600B. In some embodiments, the socket terminal 600 may be used to receive not only the insertion portion 310 of the plug terminal 300, but also at least a portion of the cable connection portion 320 of the plug terminal 300, such as the portion of the wire core connection roll 321 shown in FIG. 13.

As shown in FIG. 11, the cavity receiving portion 600B includes two bending elastic arms 604. As shown in FIG. 12, one end of the bending elastic arm 604 extends and is bent from both sides of the top wall 602, and the other end (free end) of the bending elastic arm 604 extends into the cavity receiving portion 600B. As further shown in FIG. 12, the other end of the bending elastic arm 604 includes a bending portion 6041, that is, a bending structure is provided at the end of the free end of the bending elastic arm 604. The bending portion 6041 and the bending elastic arm 604 form a V-shaped structure. A bottom end surface of the bending portion 6041 may be in contact with the plug terminal 300.

During the contact and insertion of the plug terminal 300 and the socket terminal 600, the plug terminal 300 first passes through the open receiving portion 600A. In the inserting process, the pressing portion 304 on the elastic sheet 302 is pressed by the limiting handle 605. After the insertion of the ends of the plug terminal 300, the elastic sheet 302 rebounds and makes a sound, and the limiting handles 605 are clamped with the elastic sheet 302 to lock the plug terminal 300 and the socket terminal 600.

When the plug terminal 300 enters the cavity receiving portion 600B, each contact side plate 303 is inserted between the bending portion 6041 and the bottom wall 601, and the bending elastic arms 604 press the contact side plates 303 downward. As shown in FIG. 13, an upper surface of each contact side plate 303 is in contact with the corresponding bending elastic arm 604, and a lower surface of each contact side plate 303 is pressed and in contact with the bottom wall 601.

As shown in FIG. 12, in the non-connected state, the free end of the bending elastic arm 604 may be in a non-contact state with the upper surface of the bottom wall 601, that is, the free end of the bending elastic arm 604 is suspended. In this state, the distance between the two should be less than the thickness of the contact side plate 303 to ensure good contact. In some other embodiments, the free end of the bending elastic arm 604 may be in contact with the upper surface of the bottom wall 601.

As shown in FIGS. 11-12, each side wall 603 of the socket terminal 600 also includes a stopper 614 thereon. The stopper 614 is located between the top wall 602 and the limiting handle 605. The stopper 614 is formed by bending from the top of the side wall 603 to the inside of the socket terminal 600. There is a distance between the end of the stopper 614 and the bottom wall 601 for inserting the contact side plate 303 of the plug terminal 300. When the plug terminal 300 is about to be inserted reversely, that is, when the plug terminal 300 in FIG. 11 is reversed up and down, the stopper 614 may block the insertion of the plug terminal 300, thereby improving the connection efficiency.

As shown in FIGS. 11-12, the open receiving portion 600A of the socket terminal 600 may further include two receiving guide portions 606, and the bottom wall 601 of the socket terminal 600 may be provided with at least one inward convex rib 609. In some embodiments, the top wall 602 or the side walls 603 of the socket terminal 600 may also be provided with at least one convex rib. As shown in FIG. 11, the middle position of the edge of the cavity receiving portion 600B may further include an upward protrusion 612.

As shown in FIGS. 11 and 13, the cavity receiving portion 600B further includes two receiving support portions 613, which extend from the two side walls 603 respectively and are bent toward the midline of the socket terminal 600. The receiving support portions 613 may support the bending elastic arms 604 to ensure an elastic force.

Embodiments of the present disclosure further include a connector assembly 10,30,40 comprising a connector including a plug terminal and a socket terminal. For example: (1) the connector assembly 10, as shown in FIGS. 4-5, comprises a connector including the plug terminal 100 and the socket terminal 200; (2) the connector assembly 30, as shown in FIGS. 9-10, comprises a connector including the plug terminal 300 and the socket terminal 400; and (3) the connector assembly 40, as shown in FIG. 13, comprises a connector including the plug terminal 300 and the socket terminal 600. Consequently, the connector of the connector assembly 10,30,40 has high connection reliability.

The foregoing descriptions are merely exemplary embodiments of the present disclosure, and are not intended to limit the present disclosure. Various modifications and changes may be made to the embodiments of the present disclosure by a person skilled in the art. Any modification, equivalent replacement, or improvement made without departing from the spirit and principle of the embodiments of the present disclosure shall be included in the protection of the embodiments of the present disclosure.

Although the embodiments of the present disclosure have been described with reference to several specific embodiments, it should be understood that the embodiments of the present disclosure are not limited to the disclosed specific embodiments. The embodiments of the present disclosure are intended to cover various modifications and equivalent arrangements included within the spirit and scope of the appended claims. The scope of the appended claims is to be accorded the broadest interpretation so as to encompass all such modifications and equivalent structures and functions.

1. A plug terminal, comprising:
a cable connection portion; and
an insertion portion inserted into a socket terminal, the insertion portion has a body plate, an elastic sheet having resilience, and two contact side plates, one end of the elastic sheet extends and is bent from a middle portion of the body plate, an other end of the elastic sheet extends in a direction away from the body plate, and the other end of the elastic sheet has a pressing portion, each contact side plate extends on one side of the body plate and is in electrical contact with the socket terminal.

2. The plug terminal of claim 1, wherein the two contact side plates are each bent perpendicularly from one of a left side and a right side of the body plate, the two contact side plates and the elastic sheet are on a same side of the body plate, and an outer facade of each contact side plate contacts the socket terminal.

3. The plug terminal of claim 1, wherein each contact side plate extends from one of a left side and a right side of the body plate, a contact surface of each contact side plate is in contact with the socket terminal, the elastic sheet and the contact surface of each contact side plate are on a same side of the body plate.

4. The plug terminal of claim 1, wherein the elastic sheet has a reinforcing rib, the reinforcing rib is in a middle portion of the one end of the elastic sheet and extends toward the other end of the elastic sheet.

5. The plug terminal of claim 1, wherein a width of the one end of the elastic sheet is less than a width of the other end of the elastic sheet, and a middle of the other end of the elastic sheet has a flat protrusion extending along an extension direction of the elastic sheet.

6. The plug terminal of claim 1, wherein the elastic sheet has a hole extending along an insertion direction and through the pressing portion.

7. The plug terminal of claim 1, wherein the pressing portion is curved.

8. The plug terminal of claim 1, wherein the insertion portion has two limiting side plates behind the two contact side plates in an insertion direction, each limiting side plate is bent upward from one of a left side and a right side of the body plate, a distance between the two limiting side plates is greater than a distance between the two contact side plates, and a height of the two limiting side plates is greater than a height of the two contact side plates.

9. The plug terminal of claim 1, further comprising two insertion guide portions, each insertion guide portion extends from one contact side plate and is bent toward a midline of the one end of the elastic sheet.

10. The plug terminal of claim 1, wherein the cable connection portion has a wire core connection roll and a wire shell connection roll, a center line of the wire core connection roll, a center line of the wire shell connection roll, and a center line of the insertion portion are located on a same straight line, the wire core connection roll is closer to the insertion portion than the wire shell connection roll.

11. A socket terminal, comprising:
a bottom wall;
a top wall;
two side walls;
a cavity receiving portion defined by the bottom wall, the two side walls, and the top wall; and
an open receiving portion defined by the bottom wall and the two side walls, a plug terminal is sequentially inserted into the open receiving portion and the cavity receiving portion, the open receiving portion has two limiting handles each bent from a top of one side wall, the cavity receiving portion has two bending elastic arms each extending inward of the cavity receiving portion, each bending elastic arms contacts the plug terminal.

12. The socket terminal of claim 11, wherein each bending elastic arm is bent at an edge of one side wall and extends inward of the cavity receiving portion, a bent outer surface of each bending elastic arm contacts the plug terminal.

13. The socket terminal of claim 11, wherein one end of each bending elastic arm extends and is bent from one side of the bottom wall, and an other end of each bending elastic arm extends inward of the cavity receiving portion, the other end of each bending elastic arm has a bending portion, each bending portion contacts the plug terminal.

14. The socket terminal of claim 11, wherein one end of each bending elastic arm extends and is bent from one side of the top wall, and an other end of each bending elastic arm extends inward of the cavity receiving portion, the other end of each bending elastic arm has a bending portion, each bending portion contacts with the plug terminal.

15. The socket terminal of claim 11, wherein the open receiving portion has two receiving guide portions, each receiving guide portion extends from one side wall and is bent in a direction away from a midline of the socket terminal.

16. The socket terminal of claim 11, wherein the cavity receiving portion has at least one convex rib, the at least one convex rib is on the top wall and protrudes into the cavity receiving portion.

17. The socket terminal of claim 11, wherein the open receiving portion has two side convex ribs, each side convex rib is on one side wall and protrudes into the open receiving portion.

18. The socket terminal of claim 11, wherein the cavity receiving portion has two concave side plates, each concave side plate is bent inward of the cavity receiving portion in a direction away from one side wall.

19. The socket terminal of claim 11, wherein the cavity receiving portion has two receiving support portions, each receiving support portion extends from one side wall and is bent in a direction toward a midline of the socket terminal.

20. The socket terminal according to claim 13, wherein each side wall has a stopper, the stopper is between the top wall and each limiting handle, each stopper is bent inward from a top of one side wall, the stopper blocks the plug terminal from being inserted into the socket terminal when the plug terminal is reversed up and down.

21. A connector assembly, comprising:
a plug terminal having a body plate, an elastic sheet having a resilience, and two contact side plates, one end of the elastic sheet extends and is bent from a middle portion of the body plate, an other end of the elastic sheet extends in a direction away from the body plate, and the other end of the elastic sheet has a pressing portion, each contact side plates extends on one side of the body plate; and
a socket terminal having a bottom wall, a top wall, two side walls, and a receiving portion, the receiving portion is defined by the bottom wall, the two side walls and the top wall, the receiving portion has two bending elastic arms and two limiting handles, each bending elastic arm extends inward of the receiving portion and contacts one contact side plate of the plug terminal, each limiting handle presses the elastic sheet to elastically deform the elastic sheet during insertion of the plug terminal, and each limiting handle causes the elastic sheet to rebound and lock the elastic sheet.
